(19) United States
(12) Patent Application Publication
(10) Pub. No.: US 2012/0179702 A1
(43) Pub. Date: Jul. 12, 2012

(54) METHOD FOR SETTING METADATA, SYSTEM FOR SETTING METADATA, AND PROGRAM

(75) Inventors: Yasuyuki Nozaki, Tokyo (JP); Toshiko Matsumoto, Tokyo (JP); Matsuharu Oba, Tokyo (JP)

(73) Assignee: HITACHI SOLUTIONS, LTD., Tokyo (JP)

(21) Appl. No.: 13/497,973

(22) PCT Filed: Sep. 30, 2010
(86) PCT No.: PCT/JP2010/005878

§ 371 Date: Mar. 23, 2012

(30) Foreign Application Priority Data
Sep. 30, 2009 (JP) 2009-227664

(51) Int. Cl. G06F 17/30

(52) U.S. Cl. 707/758; 707/E17.039; 707/E17.01

(57) ABSTRACT

Proposed is a method for naturally and efficiently setting metadata in the daily process of searching for files. On a file search screen, there is provided a function of determining the candidate metadata of a metadata-nonregistered file, and initiating entry of metadata with the candidate metadata having been set. Determination of the candidate metadata is performed with any of the three following methods: a method of designating as a candidate a character string of a matched search keyword described in regular expression, a method of designating as a candidate a file path or a character string in a file that matches a keyword dictionary, and a method of designating as a candidate metadata that frequently appears in metadata-registered files.

### TECHNICAL FIELD

The present invention relates to a method for setting metadata, a system for setting metadata, and a program. For example, the invention relates to a method for providing metadata during the process of searching for electronic data.

### BACKGROUND ART

In many organizations such as enterprises, a large volume of data such as files created with office software or files created by scanning paper documents is created each day and stored in a file server or the like. When a desired file is to be located in such a large volume of data, a method of searching through folders in the file server is commonly used.

However, when the folder structure is complex or when files have been put into a folder with a structure that is not the intended structure of the person who searches for a desired file, it would take quite a long time to locate such a file. As another method of searching for files, a full-text search method is known. However, this method poses at least two problems. The first problem is that some files cannot be located only by a keyword search (see FIG. 1). For example, when all documents that were created in a given period of time are to be located, retrieval of such documents would be impossible because a full-text search cannot treat a character string representing a date within a document as the “data associated with the date.” Further, as other exemplary problems, there may be cases in which, if some documents contain a word that has the same meaning as a search keyword used by a person who searches for a desired document, the desired document cannot be located, or if a customer name is described in a plurality of lines, a file that contains the customer name will not be hit even if a search is performed by the customer name (as a character string lying in a plurality of lines). As another problem, there may be cases in which a large volume of irrelevant files may be hit (see FIG. 2). For example, if a search is performed to locate a document in which a bank name is stated as a customer name, the bank name may also be stated as a transfer account name in another file, or if a search is performed by an ID such as a quotation number, the same number as the ID may be stated as the amount of money. Such problems attributable to the full-text search can occur because a keyword within a document is not treated as a character having a meaning.

Herein, there is known a method of managing documents with metadata (attribute information) associated therewith. For example, Patent Literature 1 proposes a virtual folder system. A virtual folder system is implemented by setting metadata on each file and defining a search condition to locate each metadata in each virtual folder. When the virtual folder is referred to, a file search result corresponding to the associated search condition is presented, whereby file sorting based on the search conditions is accomplished. For example, when business documents are managed, “document type name” (e.g., contract, order form, or quotation) and “issue date” are set as the metadata of all files, and a virtual folder is assigned a search condition: “Document Type Name: ‘Contract.’” Then, when the virtual folder is referred to, a list of contracts can be acquired. Likewise, if another virtual folder is assigned a search condition: “Issue Date: ‘January to March, 2009,’” documents issued in the specified period can be collected. As described above, a virtual folder system sorts files by the meaning. Thus, effective use of documents is possible.

When setting metadata on a document, a user performs the setting with reference to the original document. Many of document management products provide a metadata registration screen, so that a user manually enters metadata with reference to files. As a method for reducing the burden of such manual entry operation, there is known a method proposed in Patent Literature 2, for example, in which when a new file is stored in a folder that already has stored therein another file, metadata that is the same as the metadata of the already stored file is automatically set on the newly registered file. In addition, Patent Literature 3 proposes a method for, when a file that is intended to be registered in a small image, which represents a file whose metadata is already registered, is dragged and dropped to the small image, automatically setting the already registered metadata on the newly registered file. Further, Patent Literature 4 proposes a technique for automatically extracting metadata from a document with reference to the relationship between the content and layout of a sentence within the document.

### CITATION LIST

### Patent Literature

### {PTL 1}

JP Patent Publication (Kokai) No. 2003-323326 A

### {PTL 2}

JP Patent Publication (Kokai) No. 2009-75667 A

### {PTL 3}

JP Patent Publication (Kokai) No. 2006-209516 A

### {PTL 4}

JP Patent Publication (Kokai) No. 2005-235099 A

### SUMMARY OF INVENTION

### Technical Problem

Although the burden of the metadata entry operation is reduced according to Patent Literatures 2 to 4, it has been impossible to eliminate the need to visually check the target document to be registered before the registration. For example, according to Patent Literatures 2 and 3, it is necessary to check the content of the target document to be registered before selecting an appropriate existing file or small image for registration of the document. Further, according to Patent Literature 4, it is not necessarily the case that correct metadata can always be extracted. Thus, in practice, it is necessary to visually check if the metadata is correct and, if the metadata is found to be incorrect, modify such metadata. That is, in registration of metadata, humans should always refer to the original file and check the metadata associated therewith.

However, such a check operation is complex and cumbersome for users. For this reason, some users may be tempted to register files in a file server without setting metadata thereon, with the result that effective use of the files based on the metadata would be impossible.

The present invention has been made in view of the foregoing. The present invention provides a technique for naturally and efficiently setting metadata in the daily process of searching for files.

### Solution to Problem

In order to solve the aforementioned problem, according to the present invention, a search is executed based on a search keyword, and files that match the search keyword, which include both files whose metadata is registered (hereinafter also referred to as metadata-registered files) and files whose metadata is not registered (hereinafter also referred to as metadata-nonregistered files), are acquired from a file database. A candidate metadata determination processing unit sets metadata of one of the metadata-registered files acquired by execution of the search as the candidate metadata of one of the metadata-nonregistered files. Then, the metadata setting processing unit, in accordance with an instruction from a user, authorizes and registers the candidate metadata as the metadata to be set on the metadata-nonregistered file on a metadata setting screen. More specifically, the candidate metadata determination processing unit extracts from the metadata-registered files acquired by execution of the search a metadata-registered file that matches an entered filter condition, and sets the metadata of the extracted metadata-registered file as the candidate metadata of the metadata-nonregistered file. If the number of the candidate metadata is one, the metadata setting processing unit authorizes the candidate metadata as being unchangeable metadata, and, if the number of the candidate metadata is more than one, the metadata setting processing unit allows one of the candidate metadata to be selected.

When a search keyword is set for use in determination of the candidate metadata, the candidate metadata determination processing unit sets the search keyword as the candidate metadata if the search keyword is described in a pre-registered expression form.

When a dictionary database, which has stored therein a candidate character string that can appear as metadata, is set for use in determination of the candidate metadata, the candidate metadata determination processing unit sets the candidate character string as the candidate metadata if the candidate character string in the dictionary database is contained in a file path of or a character string in the metadata-nonregistered file.

Further features of the present invention will become apparent from the following embodiments for carrying out the present invention and the accompanying drawings.

### Advantageous Effects of Invention

According to the present invention, it is possible to naturally and efficiently set metadata in the daily process of searching for files.

### BRIEF DESCRIPTION OF DRAWINGS

FIG. 1 shows an example in which a file cannot be located by a full-text search (keyword search).

FIG. 2 shows an example in which irrelevant files are hit by a full-text search (keyword search).

FIG. 3 is a diagram showing a schematic configuration of a system for setting metadata in accordance with an embodiment of the present invention.

FIG. 4 is a diagram showing exemplary metadata.

FIG. 5 is a diagram showing exemplary dictionary data.

FIG. 6 is a diagram showing an exemplary metadata-item setting file.

FIG. 7 is a diagram showing an exemplary filter-condition setting file.

FIG. 8 is a flowchart for illustrating the overview of a search and a metadata setting process.

FIG. 9 is a flowchart for illustrating a process (details) of determining the candidate metadata.

FIG. 10 is a flowchart for illustrating a process (details) of entering metadata.

FIG. 11 is a diagram showing an exemplary search screen.

FIG. 12 is a diagram showing an exemplary (another embodiment) search screen.

FIG. 13 is a diagram showing an exemplary metadata setting screen.

FIG. 14 is a diagram showing an exemplary display screen of a list of candidate metadata.

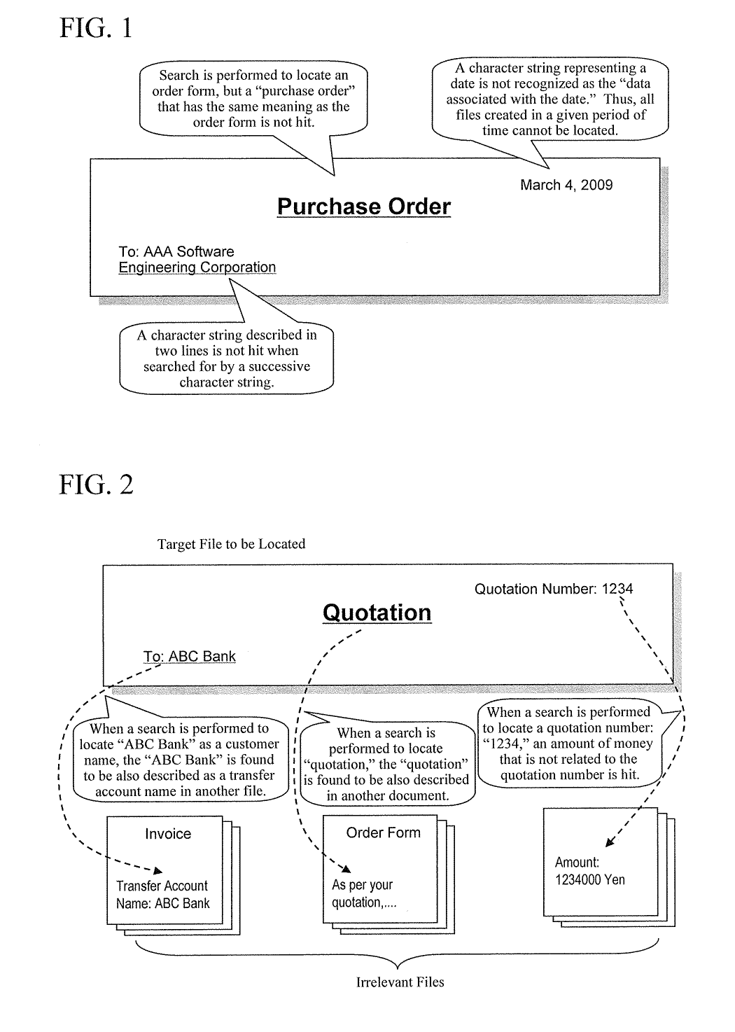

### DESCRIPTION OF EMBODIMENTS

The present invention relates to a technique for efficiently and accurately setting metadata on files whose metadata is not set yet. If metadata can be set efficiently and accurately, it becomes also possible to efficiently and accurately search for files using the metadata.

Hereinafter, a method for setting metadata in accordance with an embodiment of the present invention will be described with reference to the accompanying drawings. It should be noted that this embodiment is only illustrative for the purpose of implementing the present invention, and thus is not intended to limit the technical scope of the present invention. Structures that are common to each of the drawings are assigned identical reference numbers.

### <Configuration of a System for Setting Metadata>

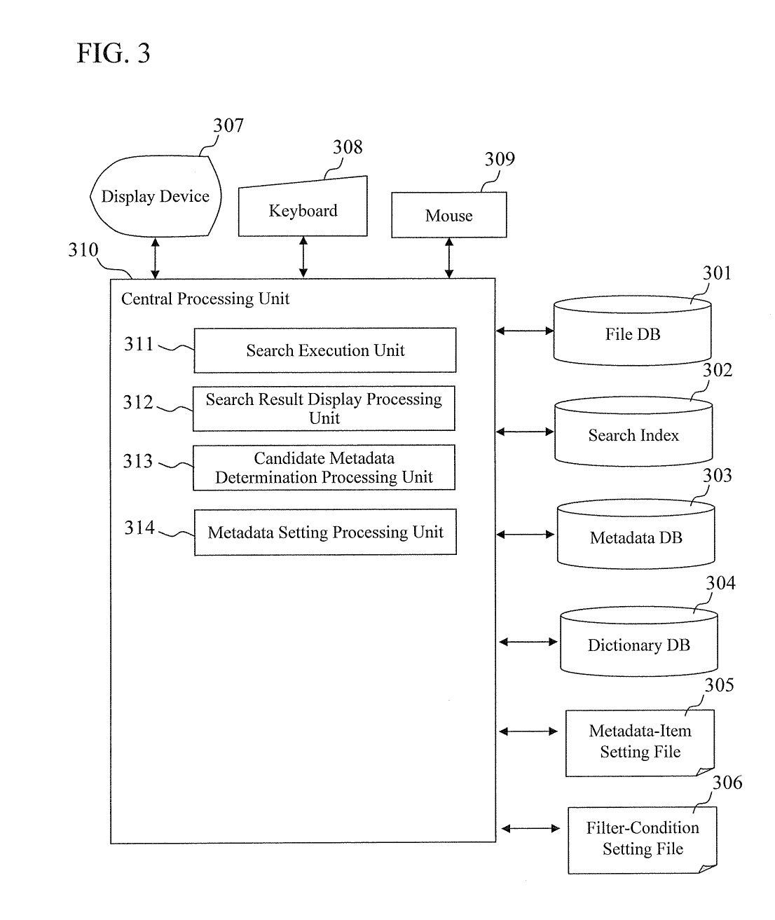

FIG. 3 is a diagram showing a schematic configuration of a system for setting metadata (a document processing system) in accordance with an embodiment of the present invention. This system includes a file DB 301 having files stored therein, an index 302 used to search for files in the file DB 301, a metadata DB 303 having stored therein registered metadata, a dictionary DB 304 having a collection of candidates that can appear as metadata (e.g., a customer name list and a product name list) to determine the candidate metadata, a metadata-item setting file 305 that describes metadata items set by the present system, a filter-condition setting file 306 used to narrow down the candidate metadata, a display device 307 that displays search results and a metadata setting screen, a keyboard 308 and a pointing device 309 such as a mouse for entering or editing data and selecting menus, and a central processing unit 310 that performs a necessary arithmetic process, control process, or the like. In the file DB 301 herein, both files whose metadata is registered (also referred to as metadata-registered files) and files whose metadata is not registered (also referred to as metadata-nonregistered files) are stored. In the search index 302, an index associated with a character string contained in a file path of each file or in each file is stored. With regard to each of file DB 301, the search index 302, the metadata DB 303, and the dictionary DB 304, the number of the physical DB entities can be more than one.

The central processing unit 310 includes a search execution unit (a search execution function) 311 that executes a keyword search to the file DB 301 using the search index 302, a search result display processing unit (a display function) 312 that executes a process for displaying an output result obtained by the search execution unit 311 on the display device 307, a candidate metadata determination processing unit (a metadata determination processing function) 313 that determines the candidate metadata of a metadata-nonregistered file using metadata-registered files, and a metadata setting processing unit (a metadata setting processing function) 314 that executes a process of setting metadata on files. The aforementioned processing units and data or programs used for such processing units can also be provided in a form stored in a recording medium such as CD-ROM, DVD-ROM, MO, floppy disk, or USB memory.

### <Metadata>

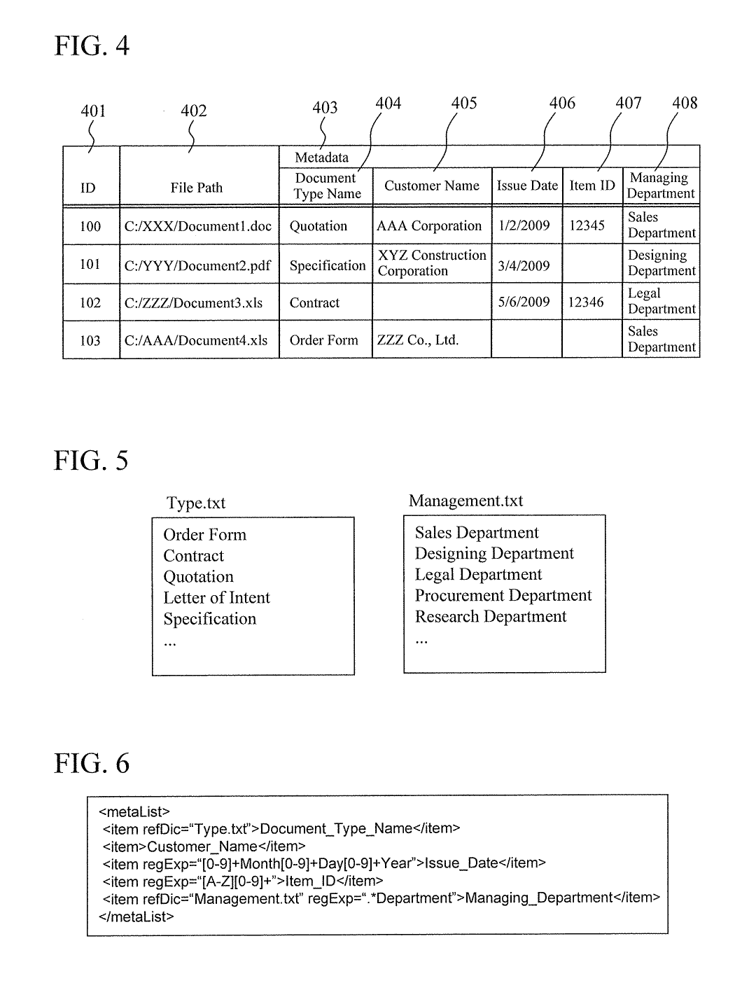

FIG. 4 is a diagram showing exemplary metadata in the metadata DB 303. In the metadata DB 303, only metadata is registered, while file entities are stored in the file DB 301. Thus, when metadata is set on a file, such metadata is registered in the metadata DB 303. When metadata is set on a file, the metadata is sequentially added to the metadata DB 303.

As shown in FIG. 4, metadata is managed in a tabular form, and a single file corresponds to a single row. The table is composed of an ID 401 that uniquely identifies a file, a file path 402 of the file, and metadata 403 registered for the file. The metadata 403 includes columns corresponding to metadata items that are managed with the present system.

In the example of FIG. 4, the metadata items include a document type name 404, customer name 405, issue date 406, item ID 407, and managing department 408. Although some cells in FIG. 4 are empty, such cells indicate the absence of corresponding metadata. Further, the constituent elements of the metadata can be added, and in that case, columns are added to the field 403 correspondingly.

### <Dictionary Data>

FIG. 5 is a diagram showing exemplary dictionary data in the dictionary DB 304. The dictionary DB 304 is composed of a list of character strings, which can appear as metadata, for each metadata item. Such a list is registered as a text file.

For example, as shown in FIG. 5, a collection of metadata keywords for the metadata item: “document type name” is registered as “Type.txt” and a collection of keywords for the metadata item: “managing department” is registered as “Management.txt.” Each keyword is entered into the dictionary DB with a line feed.

### <Metadata-Item Setting File>

FIG. 6 is a diagram showing an example of the content of the metadata-item setting file 305. The metadata-item setting file 305 is used to set the kind of metadata items that are registered with the present system. The metadata items set herein correspond to the columns of the metadata 403 in FIG. 4. The metadata-item setting file 305 is described in the XML format, and each metadata item is described as a subelement <item> of the root tag <metaList>.

When a metadata item refers to a dictionary file, “refDic” is assigned as the attribute of the <item>, and a file name of the corresponding dictionary file is described therein. Meanwhile, when a metadata item is written in a fixed format (e.g., date or ID), “regExp” is assigned as the attribute of the <item> and metadata is described therein in the form of a regular expression. When dictionary data is added, an item of “refDic” is added to the metadata-item setting file 305.

### <Filter-Condition Setting File>

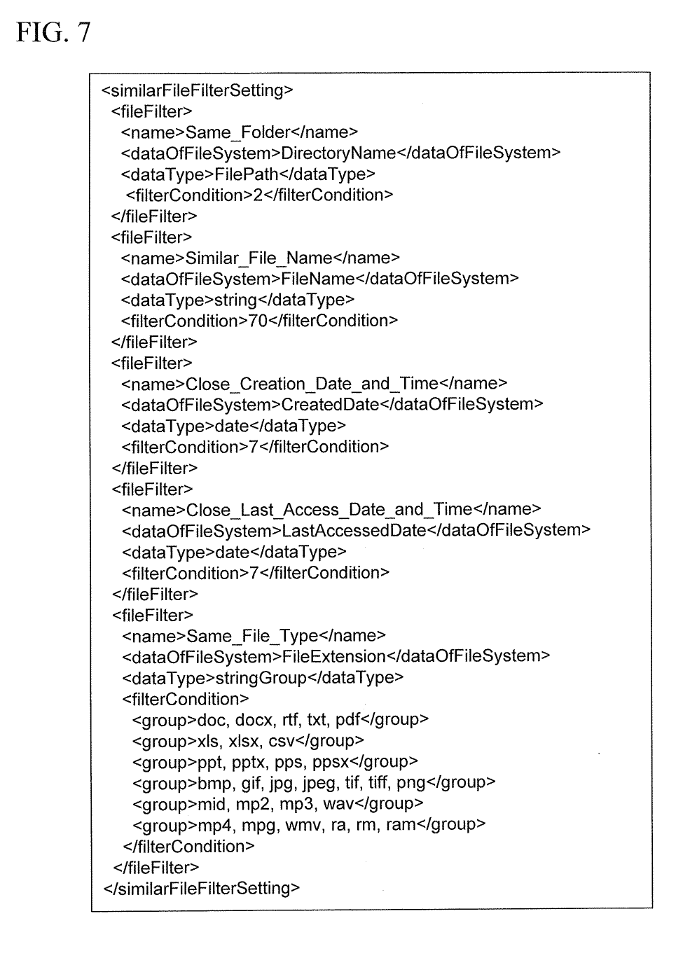

FIG. 7 is a diagram showing an example of the content of the filter-condition setting file 306. When the present system determines the candidate metadata of a metadata-nonregistered file, it uses metadata-registered files as a piece of information as described below. Then, in order to refine the candidate metadata more precisely, an operation to narrow down the metadata-registered files to determine the candidate metadata is performed. This is because if the narrowed files have similar properties to those of the metadata-nonregistered file, it is highly probable that the metadata-nonregistered file has the same metadata as those of the metadata-registered files. For example, files in the same folder may have the same metadata with high probability because such files should have been stored in the same folder for some purpose. Further, image files that were created at similar date and time may have the same metadata with high probability because such files may have been created at the same time with a multifunction printer or a scanner. In the present system, in order to narrow down the file features to a similar one, file attributes that the file system originally retains are used. The filter-condition setting file determines under which condition files should be regarded as being “similar files.” The filter-condition setting file is described in XML, and each condition is described in the subelement <fileFilter> of the root node <similarFileFilterSetting>. The subelement <fileFilter> has, as its subelements, <name> that indicates the name of a condition, <dataOfFileSystem> that indicates an attribute name on the file system that is referred to by the condition, <dataType> that indicates the data type of the attribute value, and <filterCondition> that indicates under which condition files should be regarded as being similar files. The way to analyze the value of the <filterCondition> differs depending on the <dataType>. For example, in FIG. 7, a filter condition related to “Same_Folder” is set as the first <fileFilter>. Such a filter condition describes the definition as to under which condition files should be regarded as “files in the same folder.” Herein, data of the data type “FilePath” is acquired from the file system. <filterCondition> under the type name being 2 indicates that this system is configured to regard a file that resides in a folder within two hierarchical levels from the relevant file as being a “file residing in the same folder.”

Similarly, the next <fileFilter> describes the setting as to if the file names are similar. Herein, data of the data type “string” is acquired from the file system. <filterCondition> under this data type being 70 indicates that file names in which 70% or more of the constituent characters match should be construed as being similar file names. For the next <fileFilter>, data of the data type “date” is acquired from the file system. <filterCondition> being 7 herein indicates that a file created within 7 days before and after the creation date of the relevant file should be construed as being a similar file.

The last <fileFilter> determines if the file types are the same. That is, the present system determines if the file types are the same based on the kind of extensions. That is, the system checks to which <group> in <filterCondition> a file extension belongs, and determines the other extensions described in the same group to be the same file type. Accordingly, files whose extensions are “doc,” “docx,” “rtf,” “txt,” and “pdf” can be determined to have the same file type.

### <Search and Metadata Setting Process>

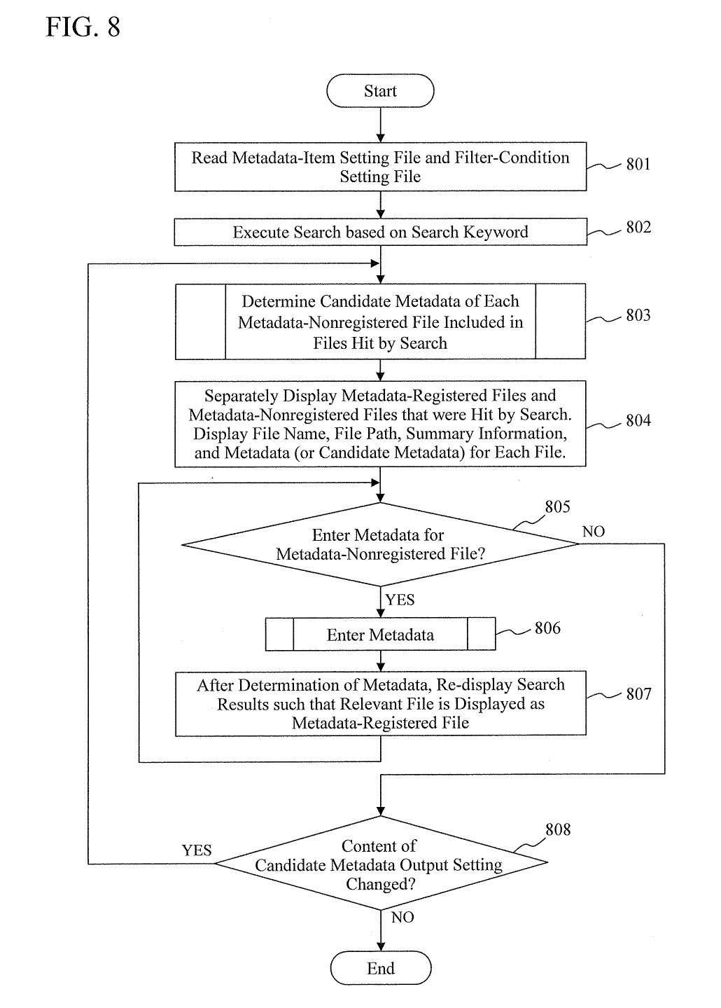

FIG. 8 is a flowchart for illustrating the overview of a search and a process of setting metadata on metadata-nonregistered files during the search.

First, the candidate metadata determination processing unit 313 reads the metadata-item setting file 305 and the filter-condition setting file 306 (step 801). Herein, it is possible to know from the metadata-item setting file 305 the metadata items set with the present system as well as the presence or absence of dictionaries related to the metadata items. It is also possible to know from the filter-condition setting file 306 the filter conditions that can be set with the present system. After such information is read, the search result display processing unit 312 displays a candidate metadata output setting screen, and accepts an entry from a user. The candidate metadata output setting screen is a screen on which it is possible to set whether to use a search keyword, whether to use dictionary data, and which filter condition is to be used.

Next, the search execution unit 311 receives a search keyword from a user, and executes a search based on the keyword using the search index 302 (step 802).

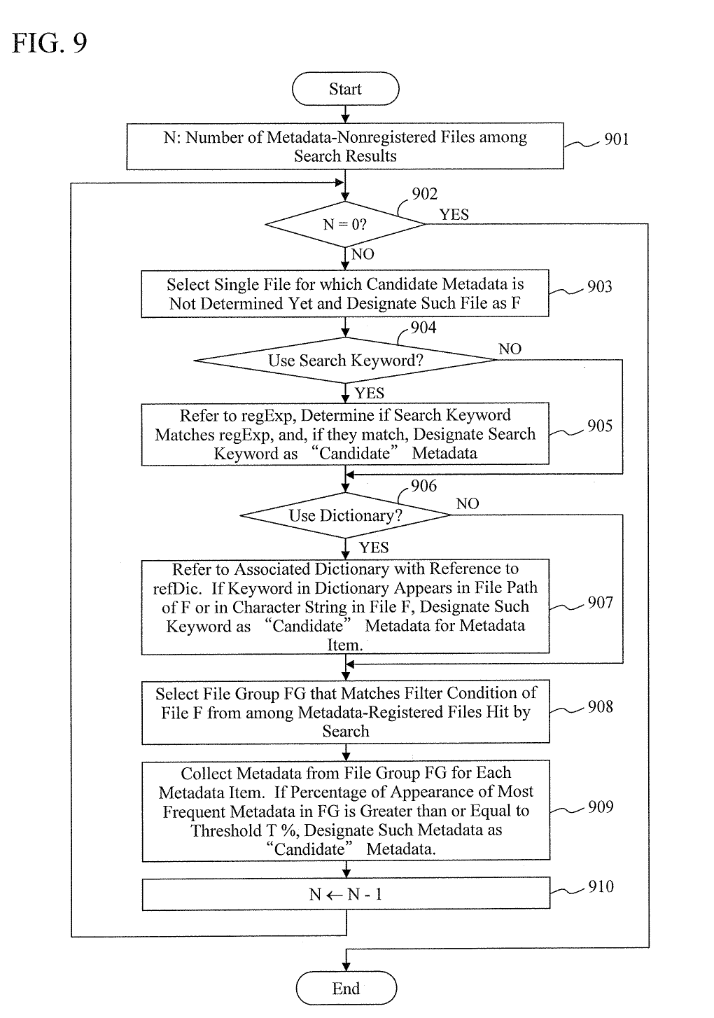

Then, the candidate metadata determination processing unit 313 determines the candidate metadata of each metadata-nonregistered file from the results of the search executed in step 802 (step 803). If metadata of a file is already registered can be determined by checking if the metadata DB 303 has the file as the metadata-registered file. The detailed process of determining the candidate metadata (step 803) will be described below (see FIG. 9).

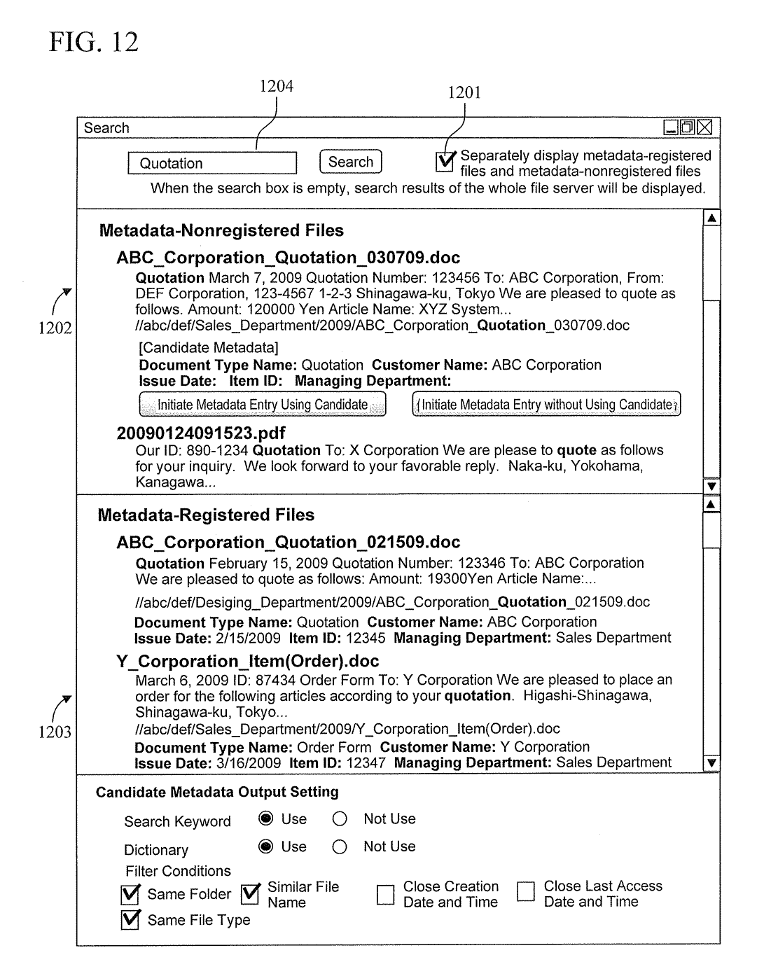

Next, the search result display processing unit 312 displays the results of the search executed in step 802 on the display device 307 as shown in FIG. 11 or FIG. 12 such that metadata-registered files are separately displayed from metadata-nonregistered files (step 804). Examples of the displayed contents related to the files include a file name, file summary information (information about character strings around the search keyword within the file), and file path. For the metadata-registered files, associated metadata is acquired from the metadata DB 303 and displayed. For the metadata-nonregistered files, the candidate metadata determined in step 803 is displayed.

The search result display processing unit 312 accepts an entry as to whether to enter metadata for each metadata-nonregistered file (step 805). There are two methods for initiating the entry. The first method is a method of initiating the entry of metadata using the candidate metadata obtained in step 803 as the metadata. The second method is a method of initiating the entry of metadata in a state in which none of the metadata items is set, i.e., without using the candidate metadata. For example, if a user can determine that the candidate metadata is correct from the file summary information or the file path displayed in step 804, the entry of metadata can be initiated with the first method. Alternatively, if the candidate metadata is determined to be incorrect or if the candidate metadata is correct cannot be known from the summary information or the file path, the entry of metadata can be initiated with the second method. In any case, entry of metadata can be initiated with a single operation. If the metadata is determined to be entered in step 805, the flow proceeds to step 806, and if not, the flow proceeds to step 808.

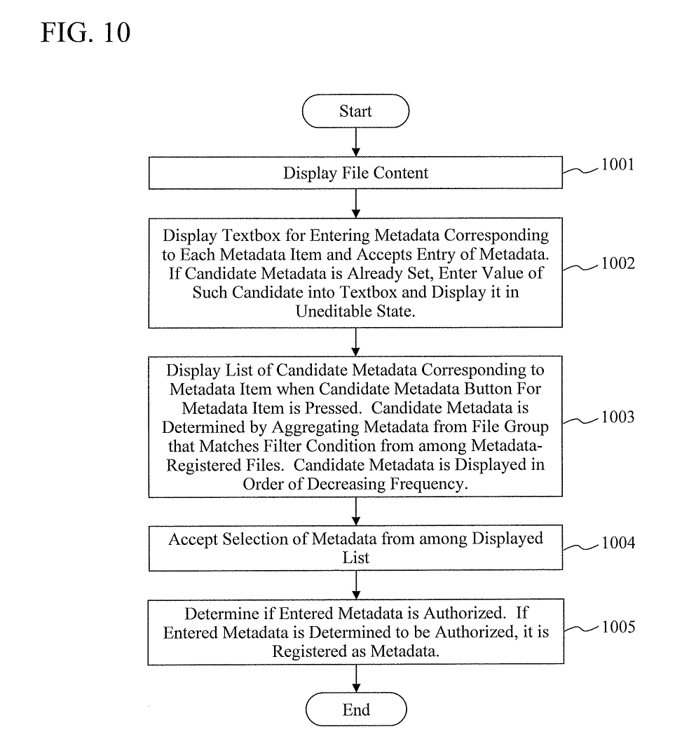

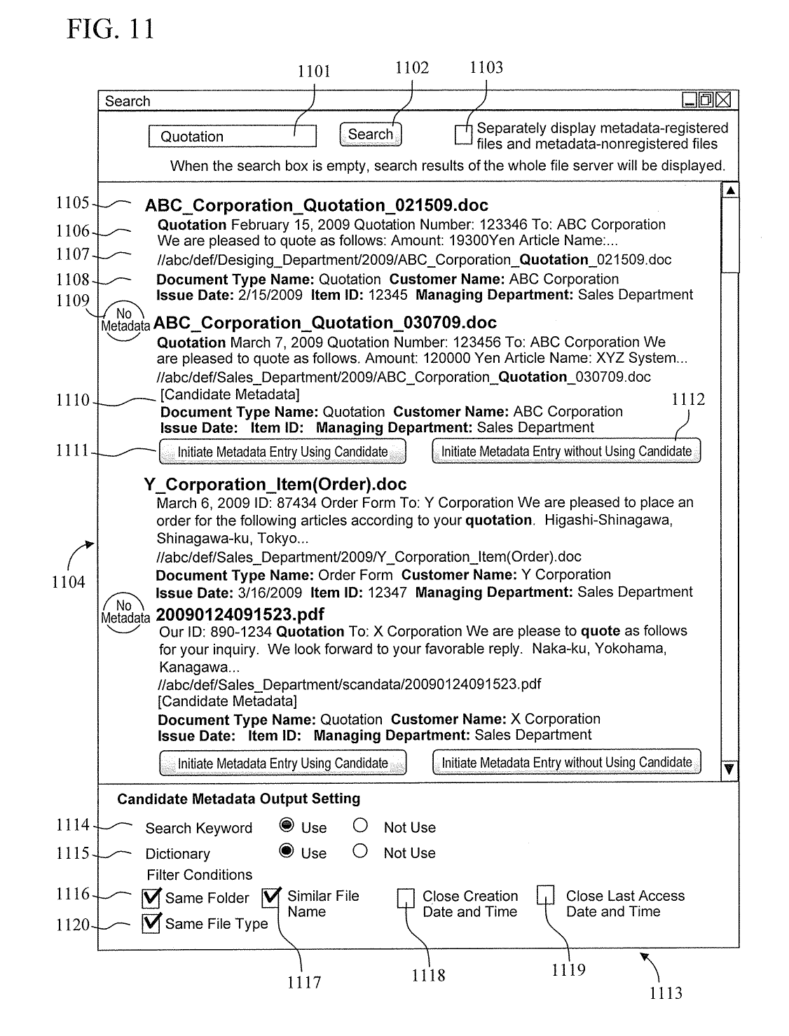

If metadata is entered for each metadata-nonregistered file (if the answer to step 805 is Yes), the metadata setting processing unit 314 performs a process of entering the metadata for the file selected in step 805 (step 806). The detailed processing will be described below (see FIG. 10).

The search result display processing unit 312, upon determination of the metadata in step 806, recognizes the file whose metadata has just been set as a metadata-registered file, and displays the search results again (step 807). After step 807, the flow returns to step 805 to continue the process.

Finally, the search result display processing unit 312 checks if the setting on the candidate metadata output setting screen displayed in step 801 has been changed (step 808), and if the setting is found to be changed (e.g., if the filter conditions and the like have been changed in FIG. 11), the flow returns to step 803 to continue the process. If no change is found, the process is terminated.

### <Process of Determining the Candidate Metadata (Details of Step 803)>

FIG. 9 is a flowchart for illustrating the details of a process of determining the candidate metadata of each metadata-nonregistered file. Candidate metadata can be determined with any of the three following methods. The first method is a method of designating a search keyword as the candidate metadata. The second method is a method of checking if a keyword in a dictionary is contained in a character string within a document of or in a file path of the metadata-nonregistered file, and, if the keyword is found to be contained therein, designating such a keyword as the candidate metadata. The third method is a method of searching for metadata that frequently appears in metadata-registered files and designating such metadata as the candidate metadata. Hereinafter, the details of such processes will be described. It should be noted that the subject that performs each step is the candidate metadata determination processing unit 313 unless otherwise stated.

First, among the search results, the number of metadata-nonregistered files is indicated by N (step 901). Hereinafter, a process will be performed on the assumption that N indicates the number of metadata-nonregistered files for which candidate metadata is not determined yet.

Next, if N is zero is determined (step 902). If N is zero, it means that the search results originally contained no metadata-nonregistered files or that (as will be understood from the following process) candidate metadata has been determined for all of the metadata-nonregistered files. If N is zero, the process is terminated, and if N is not zero, the flow proceeds to the next step 903.

Then, one of the files for which candidate metadata is not determined yet is selected. Such a file is indicated by F (step 903).

Whether to use a search keyword, which is used in the current search, as the candidate metadata is read from the candidate metadata output setting pane (for example, if the “search keyword” is set to “use” in the candidate metadata output setting pane in FIG. 11 is checked) (step 904). If the search keyword is determined to be used, the flow proceeds to the next step 905, and if not, the flow proceeds to step 906.

Further, the possibility of whether the search keyword can be the candidate metadata is determined (step 905). Specifically, the value of a regular expression described in the attribute “regExp” of the <item> tag in the metadata-item setting file 305 is read, and if the value matches the search keyword, such a search keyword is designated as the “candidate” metadata of the corresponding metadata item <item>. For example, if the search keyword is “designing department,” it corresponds to “regExp=*Department.” Thus, the search keyword “designingdepartment” is designated as the candidate metadata. It should be noted that if the search keyword matches the regular expressions of two or more metadata items, or if the search keyword does not match any of the regular expressions, such a search keyword is not designated as the candidate metadata.

Likewise, whether to determine the candidate metadata using a dictionary is read from the candidate metadata output setting pane (step 906). If the candidate metadata is determined using a dictionary, the flow proceeds to the next step 907, and if not, the flow proceeds to step 908.

Then, a process of determining the candidate metadata using a dictionary is performed (step 907). Specifically, a dictionary given by the attribute “refDic” of the <item> tag in the metadata-item setting file 305 is referred to. If a keyword in the dictionary is found to appear in the file path of the file F or in a character string within the file F, such a keyword is designated as the candidate metadata of the corresponding metadata item <item>. When a plurality of keywords in the dictionary appear in the file path of the file F or within the file F or when none of the keywords in the dictionary appears, no keyword in the dictionary is designated as the candidate metadata.

The aforementioned steps 905 and 907 are the processes of determining the candidate metadata using a metadata-registered file. Meanwhile, in step 908, which filter condition is specified is read from the candidate metadata output setting pane. Then, among the metadata-registered files, files that match the specified filter condition of the file F are selected (if there is no filter condition specified, all of the metadata-registered files are selected). If any of the metadata-registered files matches the filter condition is determined based on the content of the filter-condition setting file 306. The files selected herein are referred to as a file group FG.

Next, metadata corresponding to each metadata item (item included in the field 403) (step 909) is collected from the file group FG. If the percentage of the appearance of the most frequent metadata in the FG is greater than or equal to a threshold T %, such metadata is designated as the “candidate” metadata. For example, provided that the file group FG includes 100 files and the metadata item “document type name” is collected therefrom, if the metadata of 80 files indicates “quotation” and if the threshold T is 80% or less, the “quotation” can be designated as the candidate. Metadata corresponding to the other metadata items is aggregated in a similar way and the percentage of the appearance of the most frequent metadata is compared with the threshold. If the percentage is greater than or equal to the threshold, such metadata is designated as the candidate.

Further, as the candidate metadata of a single metadata-nonregistered file has been determined, N−1 is overwritten with N, and the flow returns to step 902 to proceed with the process (step 910).

In FIG. 9, in order to determine the candidate metadata, a search keyword is used (steps 904 and 905), and a dictionary is used thereafter (steps 906 and 907), and finally a keyword that frequently appears in the metadata-registered files is used (steps 908 and 909). However, the aforementioned order can be changed.

Meanwhile, when there is a plurality of candidates for a metadata item (for example, when a candidate is determined using a search keyword first, and thereafter another candidate is determined using a dictionary), the previously determined candidate can be overwritten with the newly determined candidate. Alternatively, the previously determined candidate can always be used.

### <Details of Metadata Entry Process (Step 806)>

FIG. 10 is a flowchart for illustrating the details of a process of entering metadata for a metadata-nonregistered file.

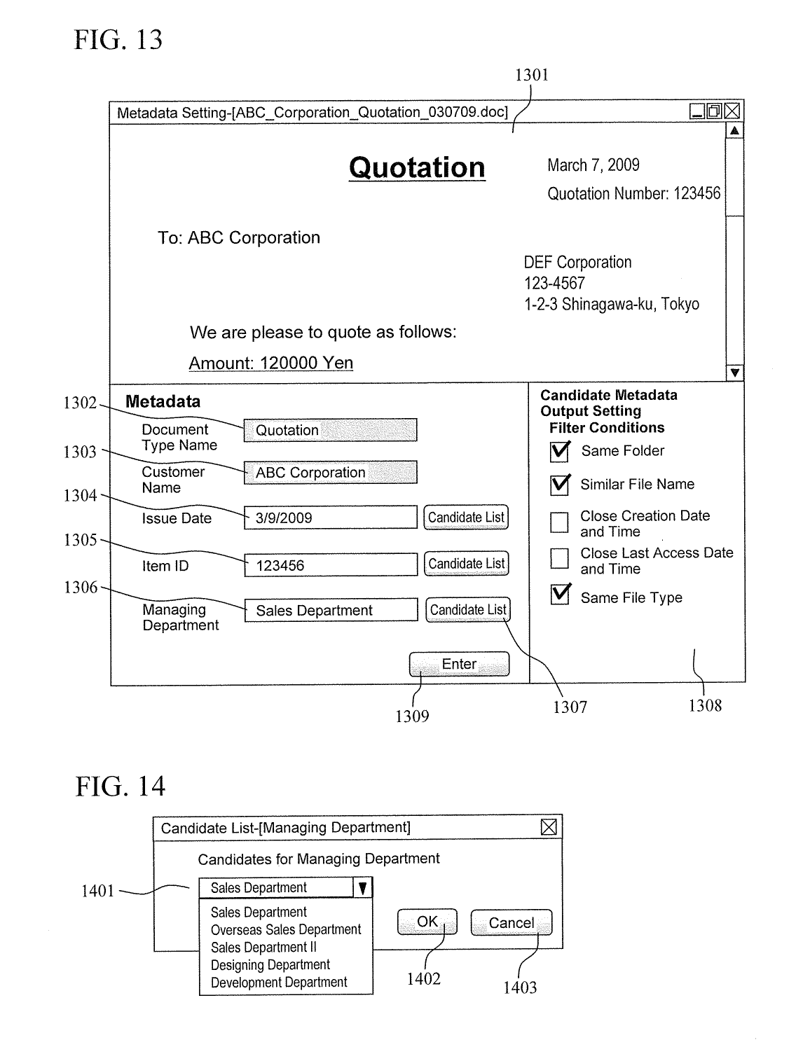

First, the search result display processing unit 312 displays the content of a metadata-nonregistered file as shown in FIG. 13 (step 1001).

Next, the metadata setting processing unit 314 displays a text box for entering metadata corresponding to each metadata item and accepts an entry of metadata (step 1002). At this time, if entry of metadata has already been initiated with the candidate metadata adopted as the metadata in step 805, the value of such candidate metadata is entered into the text box and is displayed in an uneditable state.

The metadata setting processing unit 314 accepts an entry of whether to list the candidate metadata corresponding to each metadata item (detects if the candidate metadata button is pressed), and displays the list of candidate metadata corresponding to the metadata item (step 1003). The list of candidate metadata herein is determined by aggregating metadata from a file group that matches a given filter condition from among the metadata-registered files. The candidate metadata is displayed in the order of decreasing frequency.

Further, the metadata setting processing unit 314 accepts selection of metadata by a user from among the list displayed in step 1003 (step 1004).

Finally, the metadata setting processing unit 314 determines if the entered metadata has been authorized by the user (step 1005). If the entered metadata is determined to have been authorized by the user, it is registered as the metadata in the metadata DB 303. Then, the process is terminated.

### <Example of Search Screen>

FIG. 11 is a diagram showing an exemplary search screen of the present system. When a user enters a search keyword into a text box 1101 and presses a search execution button 1102, a search is executed. Search results can be displayed such that both the metadata-registered files and metadata-nonregistered files are displayed in a mixed manner. Alternatively, such files can be displayed separately. The display can be switched with a check box 1103. The configuration of FIG. 11 shows an example in which both the files are displayed in a mixed manner.

Files hit by the search are displayed in a search result display pane 1104. Each of the hit files is displayed with its file name 1105, file summary information 1106, and file path 1107. For a metadata-registered file, metadata 1108 thereof is also displayed. Meanwhile, a metadata-nonregistered file is displayed with a sign 1109 indicating the absence of metadata. In addition, candidate metadata 1110 of the file is determined and displayed. When entry of metadata is initiated by adopting the candidate metadata 1110, a button 1111 is pressed, whereas when entry of metadata is initiated without adopting the candidate metadata, a button 1112 is pressed. For example, if a user determines that the metadata is obviously correct viewing the summary display or file path displayed on the screen, he/she presses the button 1111 to initiate the entry of the metadata.

The candidate metadata can be set on a candidate metadata output setting pane 1113 and adjusted so that appropriate candidate metadata is presented. For example, when a search keyword is used to determine the candidate metadata, candidates are selected using a radio button 1114, whereas when dictionary data is used, candidates are selected using a radio button 1115. Further, when candidate metadata is selected from among the metadata of the metadata-registered files, narrowing (filtering process) can be performed to the metadata-registered files using the attributes of the file system so that more accurate candidate metadata can be presented. For example, when the files are narrowed down to files in the same folder, a check box 1116 is checked. Likewise, when the files are narrowed down to files whose file names are similar, a check box 1117 is checked; when narrowed down to files whose creation date and time are close, a check box 1118 is checked; when narrowed down to files whose last access date and time is close, a check box 1119 is checked; and when are narrowed down to files of the same file type, a check box 1120 is checked. When the setting of the candidate metadata output setting pane 1113 is changed, the candidate metadata 1110 of each file on the search result display pane 1104 is re-determined and displayed again.

FIG. 12 is a diagram showing another exemplary search screen of the present system. FIG. 12differs from FIG. 11 in that a check box 1201 (1103 in FIG. 11) is checked. Then, search results are displayed such that metadata-nonregistered files and metadata-registered files are separately displayed on a non-registered file display pane 1202 and a registered file display pane 1203, respectively. With such a display configuration, a user can concentrate on the operation to enter metadata. Further, metadata-nonregistered files can be found easily.

Meanwhile, the display configuration of FIG. 11 is the conventional display of search results, which is an interface that would not feel cumbersome for a user if he/she mainly wants to execute a search.

With a display configuration such as the one shown in FIG. 12, when a search is executed with “quotation” entered into a text box 1204, a number of files related to quotations will be hit. Thus, such a configuration is convenient and efficient when metadata is to be set intensively for files of quotations. Further, when a search is executed with no keyword entered into the text box 1204 for entering a search keyword, all files included in the file server can be displayed. Accordingly, all metadata-nonregistered files can be displayed and metadata can be set thereon without omission.

### <Metadata Setting Screen>

FIG. 13 is a diagram showing an exemplary metadata setting screen of the present system. A file being selected is displayed in a file display area 1301 on the metadata setting screen. A user sets metadata while viewing the displayed file. Metadata is displayed in a text box for each metadata item.

In FIG. 13, a document type name is displayed in a text box 1302, a customer name is displayed in a text box 1303, an issue date is displayed in a text box 1304, an item ID is displayed in a text box 1305, and a managing department is displayed in a text box 1306. On the search screen, when entry of metadata is initiated by adopting the candidate metadata (when entry of metadata is initiated by pressing the button 1111 in FIG. 11), the metadata items that have already been set are configured to be not editable (the text boxes 1302 and 1303 in FIG. 13). With such a display configuration, a user can narrow the range of metadata items to be set. Thus, metadata can be registered more efficiently. Such a configuration is particularly effective when there is a large number of metadata items. When a candidate list button 1307 for each metadata item is pressed, a list of candidate metadata for the corresponding metadata item is displayed in the order of decreasing accuracy. The candidate list and the displayed order of the list can be adjusted on a candidate metadata output setting pane 1308. A user can either select appropriate metadata from the candidate list or directly enter metadata into the text box. When all of metadata have been entered and an “Enter” key 1309 is pressed, the entered metadata is registered in the system.

FIG. 14 shows an exemplary screen that displays a candidate list. Specifically, FIG. 14 shows a screen displayed when the candidate list button 1307 in FIG. 13 is pressed. The candidate list is displayed in the form of a drop-down list 1401, and candidate metadata is displayed in the order of decreasing accuracy. When a user selects one of the candidate metadata from the list and presses an “OK” button 1402, the selected metadata is entered into the text box in FIG. 13. When the user presses “Cancel” button 1403, metadata is not entered and the screen is closed.

### CONCLUSION

According to the present invention, a search is executed based on a search keyword, and files that match the search keyword, which include both metadata-registered files and metadata-nonregistered files, are acquired from a file database. Then, the metadata-registered files, which have been acquired by execution of the search, are narrowed down by a filter condition (for example, see FIG. 7), and metadata of the narrowed metadata-registered file is set as the candidate metadata of the metadata-nonregistered file. Then, the metadata setting processing unit, in accordance with an instruction from a user, authorizes (makes uneditable) and registers the candidate metadata as the metadata to be set on the metadata-nonregistered file, on the metadata setting screen. Accordingly, metadata of a file can be efficiently set. That is, although the operation to register metadata is always visually checked, it is not necessary to check or edit all of the metadata items. Thus, registration of metadata can be simplified. Further, as the registration of metadata is naturally performed in the daily process of searching a file server, stress-free metadata setting for users can be realized.

When there is a single piece of candidate metadata, the candidate metadata is authorized as being unchangeable data. However, when there is a plurality of pieces of candidate metadata, one of them is configured to be selectable. In this manner, not all pieces of metadata are configured to be uneditable, but metadata is configured to be set flexibly, whereby the accuracy of metadata setting can be improved.

When a search keyword is set for use in determination of the candidate metadata, the candidate metadata determination processing unit sets the search keyword as the candidate metadata if the search keyword is described in a pre-registered expression form. Further, when a dictionary database, which has stored therein a candidate character string that can appear as metadata, is set for use in determination of the candidate metadata, the candidate metadata determination processing unit sets the candidate character string as the candidate metadata if the candidate character string in the dictionary database is contained in a file path of or a character string in the metadata-nonregistered file. Accordingly, metadata can be set in association with a search keyword or with a file path.

It should be noted that the present invention can also be realized by a program code of software that implements the function of the embodiment. In such a case, a storage medium having recorded thereon the program code is provided to a system or an apparatus, and a computer (or a CPU or a MPU) in the system or the apparatus reads the program code stored in the storage medium. In this case, the program code itself read from the storage medium implements the function of the aforementioned embodiment, and the program code itself and the storage medium having recorded thereon the program code constitute the present invention. As the storage medium for supplying such a program code, for example, a flexible disk, CD-ROM, DVD-ROM, a hard disk, an optical disc, a magneto-optical disc, a CD-R, a magnetic tape, a nonvolatile memory card, ROM, or the like is used.

Further, based on an instruction of the program code, an OS (operating system) running on the computer or the like may perform some or all of actual processes, and the function of the aforementioned embodiment may be implemented by those processes. Furthermore, after the program code read from the storage medium is written to the memory in the computer, the CPU or the like of the computer may, based on the instruction of the program code, perform some or all of the actual processes, and the function of the aforementioned embodiment may be implemented by those processes.

Moreover, the program code of the software that implements the function of the embodiment may be distributed via a network, and thereby stored in storage means such as the hard disk or the memory in the system or the apparatus, or the storage medium such as a CD-RW or the CD-R, and at the point of use, the computer (or the CPU or the MPU) in the system or the apparatus may read the program code stored in the storage means or the storage medium and execute the program code.

### REFERENCE SIGNS LIST

301 file DB
302 search index
303 metadata DB
304 dictionary DB
305 metadata-item setting file
306 filter-condition setting file
307 display device
308 keyboard
309 mouse
310 central processing unit
311 search execution unit
313 candidate metadata determination processing unit
314 metadata setting processing unit
401 file ID
402 file path
403 whole metadata
404 document type name
405 customer name
406 issue date
407 item ID
408 managing department
1101 text box to enter search keyword
1102 search execution button
1103 check box to determine whether to separately display metadata-registered files and metadata-nonregistered files
1104 search result display pane
1105 file name of file hit by search
1106 summary information of file hit by search
1107 file path of file hit by search
1108 metadata of file hit by search
1109 sign indicating that metadata is not registered yet
1110 candidate metadata of file hit by search
1111 button to initiate metadata entry by using candidate metadata
1112 button to initiate metadata entry without using candidate metadata
1113 candidate metadata output setting pane
1114 radio button to determine whether to use search keyword
1115 radio button to determine whether to use dictionary
1116 check box to determine whether to select files in the same folder according to filter condition
1117 check box to determine whether to select files with similar file names according to filter condition
1118 check box to determine whether to select files whose creation date and time are close according to filter condition
1119 check box to determine whether to select files whose last access date and time are close according to filter condition
1120 check box to determine whether to select files of the same file type according to filter condition
1201 check box to determine whether to separately display metadata-registered files and metadata-nonregistered files
1202 display pane for metadata-nonregistered files
1203 display pane for metadata-registered files
1204 text box to enter search keyword
1301 file display area
1302 text box indicating metadata associated with document type name
1303 text box indicating metadata associated with customer name
1304 text box indicating metadata associated with issue date
1305 text box indicating metadata associated with item ID
1306 text box indicating metadata associated with managing department
1307 candidate list button that displays list of candidate metadata
1308 candidate metadata output setting pane
1309 Enter button
1401 drop-down list showing list of candidate metadata
1402 OK button
1403 Cancel button

1. A metadata setting method for setting metadata on an electronic file, comprising:
a search execution step in which a search execution unit executes a search based on a search keyword, and acquires files that match the search keyword from a file database, the files including metadata-registered files and metadata-nonregistered files;
a search result display step in which a search result display processing unit displays as a search result the metadata-registered files and the metadata-nonregistered files acquired in the search execution step;
a candidate metadata determination processing step in which a candidate metadata determination processing unit sets metadata of one of the metadata-registered files acquired in the search execution step as candidate metadata of one of the metadata-nonregistered files;
a metadata setting screen display step in which the search result display processing unit displays on a display unit a metadata setting screen for a metadata-nonregistered file selected by a user; and
a metadata registration step in which a metadata setting processing unit, in accordance with an instruction from a user, authorizes and registers the candidate metadata as the metadata to be set on the metadata-nonregistered file, on the metadata setting screen.

2. The metadata setting method according to claim 1, wherein in the candidate metadata determination processing step, the candidate metadata determination processing unit extracts from the metadata-registered files acquired in the search execution step a metadata-registered file that matches an entered filter condition, and sets the metadata of the extracted metadata-registered file as the candidate metadata of the metadata-nonregistered file.

3. The metadata setting method according to claim 1, wherein in the candidate metadata determination processing step, when the search keyword is set for use in determination of the candidate metadata, the candidate metadata determination processing unit sets the search keyword as the candidate metadata if the search keyword is described in a pre-registered expression form.

4. The metadata setting method according to claim 1, wherein in the candidate metadata determination processing step, when a dictionary database, which has stored therein a candidate character string that can appear as metadata, is set for use in determination of the candidate metadata, the candidate metadata determination processing unit sets the candidate character string as the candidate metadata if the candidate character string in the dictionary database is contained in a file path of or a character string in the metadata-nonregistered file.

5. The metadata setting method according to claim 1, wherein in the metadata registration step, if the number of the candidate metadata is one, the metadata setting processing unit authorizes the candidate metadata as being unchangeable metadata, and, if the number of the candidate metadata is more than one, the metadata setting processing unit allows one of the candidate metadata to be selected.

6. A metadata setting system for setting metadata on an electric file, comprising:
a file database having stored therein metadata-registered files and metadata-nonregistered files;
a search execution unit configured to execute a search based on a search keyword and acquire from the file database files that match the search keyword, the files including metadata-registered files and metadata-nonregistered files;
a search result display processing unit configured to display, as a search result, on a display unit the metadata-registered files and the metadata-nonregistered files acquired by the search execution unit;
a candidate metadata determination processing unit configured to set metadata of one of the metadata-registered files acquired by the search execution unit as candidate metadata of one of the metadata-nonregistered files; and
a metadata setting processing unit configured to execute a process of setting metadata, wherein when the search result display processing unit displays on the display unit a metadata setting screen for a metadata-nonregistered file selected by a user, the metadata setting processing unit, in accordance with an instruction from a user, authorizes and registers the candidate metadata as the metadata to be set on the metadata-nonregistered file, on the metadata setting screen.

7. The metadata setting system according to claim 6, wherein the candidate metadata determination processing unit extracts from the metadata-registered files acquired by the search execution unit a metadata-registered file that matches an entered filter condition, and sets the metadata of the extracted metadata-registered file as the candidate metadata of the metadata-nonregistered file.

8. The metadata setting system according to claim 6, wherein when the search keyword is set for use in determination of the candidate metadata, the candidate metadata determination processing unit sets the search keyword as the candidate metadata if the search keyword is described in a pre-registered expression form.

9. The metadata setting system according to claim 6, further comprising a dictionary database having stored therein a candidate character string that can appear as metadata, wherein if the dictionary database is set for use in determination of the candidate metadata, the candidate metadata determination processing unit sets the candidate character string as the candidate metadata if the candidate character string in the dictionary database is contained in a file path of or a character string in the metadata-nonregistered file.

10. The metadata setting system according to claim 6, wherein if the number of the candidate metadata is one, the metadata setting processing unit authorizes the candidate metadata as being unchangeable metadata, and, if the number of the candidate metadata is more than one, the metadata setting processing unit allows one of the candidate metadata to be selected.

11. A program for causing a computer to execute the metadata setting method according to claim 1.
